(19) United States
(12) Patent Application Publication
(10) Pub. No.: US 2020/0257311 A1
(43) Pub. Date: Aug. 13, 2020

(54) CART HAVING LEADING AND FOLLOWING FUNCTION

(71) Applicant: TWINNY Co., Ltd., Daejeon (KR)

(72) Inventors: Taehyoung KIM, Daejeon (KR); Jaihoon LEE, Daejeon (KR); Ayoung KWON, Daejeon (KR); Jaesung KIM, Daejeon (KR); Hongseok CHEON, Daejeon (KR); Sijong KIM, Daejeon (KR)

(21) Appl. No.: 16/680,065

(22) Filed: Nov. 11, 2019

(30) Foreign Application Priority Data
Feb. 7, 2019 (KR) 10-2019-0014361

(51) Int. Cl. G05D 1/02

(52) U.S. Cl. CPC G05D 1/0289; G05D 1/0212; G05D 1/0238; G05D 1/0295

(57) ABSTRACT

The present invention relates to a cart having a leading and following function. More particularly, the present invention relates to a cart having a leading and following function and which follows a specific subject, and, when a following subject is present, decreases in velocity or stops moving, whereby the following subject can easily follow same.

### CROSS REFERENCE TO RELATED APPLICATION

The present application claims priority to Korean Patent Application No. 10-2019-0014361, filed Feb 7, 2019, the entire contents of which is incorporated herein for all purposes by this reference.

### TECHNICAL FIELD

The present invention relates to a cart having a leading and following function. More particularly, the present invention relates to a cart having a leading and following function and which follows a specific subject, and when a following subject is present, decreases in velocity or stops moving, whereby the following subject can easily follow the same.

### BACKGROUND

Unmanned autonomous driving systems have been developed and applied in various fields for user convenience, convenience in performing specific tasks, saving in labor costs, etc.

Generally, an unmanned autonomous driving system is an autonomous system driving without a driver.

Generally, such an unmanned autonomous driving system is mainly applied to industrial fields, military fields, and dangerous work fields, and recently it has been applied to general use.

An unmanned autonomous driving system drives a predetermined trajectory or drives by planning a trajectory by itself.

In the former case, the unmanned autonomous driving system drives a predetermined trajectory by using a GPS or by using dedicated roads or railways developed for the trajectory.

However, in the former case, development and installation cost is large, since the predetermined dedicated roads or railways are used, and thus the system is limited in applications to various fields.

In addition, in the later case, the unmanned autonomous driving system has to move by generating a trajectory to the destination, and arrive there without colliding with adjacent obstacles. A good trajectory means the shortest trajectory where a movement trajectory to a destination is minimum, or a safe trajectory where energy consumption is minimum, where a driving time is minimum, or collisions with surrounding obstacles are minimum.

Generally, safe trajectories are most important in the application field of robot. However, the optimal trajectory may be the shortest while being the safest.

Generally, as a method of ensuring a safe trajectory, there is used a method of determining a direction where an empty space is large by using obstacle detecting sensors installed in the robot (devices measuring a distance with nearby obstacles, such as laser or ultrasonic waves, etc.) and determining a movement direction of robot by taking into account a direction to a destination. Weighting factors for a direction to an empty space and for a direction to a destination are determined experimentally. When a large weighting factor is given to an empty space, collision with surrounding obstacle may be minimized, but a long trajectory may be obtained, and in extreme cases, the robot may not get to the destination. On the contrary, when a large weighting factor is given to a destination, safety is degraded.

A fundamental driving performance of an autonomous driving robot is an intelligent navigation capability of moving along an optimal trajectory to a destination without collisions. For the intelligent navigation capability, a trajectory planning technique and a location recognition technique are required. However, those techniques require a large amount of calculation.

Korean Patent Application Publication No. 10-2015-0008490 discloses a method and system for autonomous tracking of a following vehicle on a trajectory of a leading vehicle.

### SUMMARY

Accordingly, the present invention has been made keeping in mind the above problems occurring in the related art, and an objective of the present invention is to provide a cart having a leading and following function, wherein the cart detects identification information assigned to a specific subject, follows the specific subject as a leading subject on the basis of the detected information, and when a following subject that follows the cart is present, deceases in velocity or stops moving according to a situation, whereby the following subject can easily follow same.

Technical tasks obtainable from the present invention are non-limited the above-mentioned technical task, and other unmentioned technical tasks can be clearly understood from the following description by those having ordinary skill in the technical field to which the present invention pertains.

In order to achieve the above object, according to one aspect of the present invention, there is provided a cart having a leading and following function, wherein the cart having the leading and following function 1000 follows a leading subject, the cart including: a cart body 100; a driving unit 200 configured with a motor and wheels for driving, and coupled to the cart body 100; an identification unit 300 provided with identification information; a subject identification storage unit 400 for storing identification information on the leading subject, a following subject, or the leading subject and the following subject; an information obtaining unit 500 obtaining surrounding information; and a control unit 900: controlling the driving unit 200 to follow the leading subject by planning a movement trajectory on the basis of the identification information on the leading subject, state information on the leading subject, and surrounding environmental information, which are determined from information obtained by the information obtaining unit 500, when the identification information on the leading subject is stored in the subject identification storage unit 400; and controlling the driving unit 200 to decrease in velocity or stop when the identification information on the following subject is stored in the subject identification storage unit 400, and when a distance with the following subject becomes equal to or greater than a specific distance, when the identification information on the following subject is not detected by the information obtaining unit 500, or when the identification information on the following subject is not detected and a predetermined time has elapsed.

In addition, the state information may include distance information and posture information on the movement trajectory, and the environmental information includes static obstacle information and dynamic obstacle information.

In addition, the information obtaining unit 500 may obtains the state information, environmental information, or the state information and the environmental information.

In addition, the information obtaining unit 500 may includes: a forward information obtaining unit 510 obtaining forward information; and a backward information obtaining unit 520 obtaining backward information.

In addition, the information obtaining unit 500 may determines the identification information on the leading subject to be stored in the subject identification storage unit 400 from information obtained by the forward information obtaining unit 510, and determine the identification information on the following subject to be stored in the subject identification storage unit 400 from information obtained by the backward information obtaining unit 520.

In addition, the forward information obtaining unit 510 and the backward information obtaining unit 520 may be respectively provided with a camera or a vision sensor.

In addition, the forward information obtaining unit 510 may determine the identification information on the leading subject to be stored in the subject identification storage unit 400 from the information obtained by the forward information obtaining unit 510, and the backward information obtaining unit 520 may determine the identification information on the following subject to be stored in the subject identification storage unit 400 from information obtained by the backward information obtaining unit 520.

In addition, the control unit 900 may estimate a trajectory of the leading subject on the basis of a position and a direction of the cart having the leading and following function and a position and a direction of the leading subject by using interpolation, and plan the movement trajectory of the cart having the leading and following function to follow the trajectory.

In addition, the control unit 900 may control the driving unit 200 by using driving modes including: a stop mode stopping at a given maximum velocity and maintaining a stop state; a standby mode stopping at a predetermined acceleration and maintaining a stop state; a tracking mode following the planned movement trajectory according to a preset operation method; and a following mode following the leading subject while maintaining a distance D with the leading subject, wherein priorities of the driving modes are in an order of the stop mode, the standby mode, the tracking mode, and the following mode.

In addition, the control unit 900 may control the driving unit 200: in the stop mode when collision with an external obstacle is expected within a designated time, when no more trajectory to move remains, and when an external stop button is activated; in the standby mode when the distance with the following subject registered on the movement trajectory becomes equal to or greater than a specific distance L, and when a recognition failure elapsing time tᵢₙᵥ measured from a moment where the following subject is recognized is equal to or greater than a predefined maximum waiting time t_{inv,threshold}; in the tracking mode when the identification information on the leading subject is not detected; and in the following mode when the other modes are not operated, wherein the specific distance L varies according to a driving situation.

According to a cart having a leading and following function according to an embodiment of the present invention, carts having a leading and following function can autonomously move in a line along a movement trajectory of the leading subject by controlling the first leading subject and without additionally controlling the carts having the leading and following function which follow the leading subject, and thus manpower and calculation required for movement in a line can be minimized.

In addition, when it is determined that the following subject does not follow normally the leading subject, waiting for the following subject can be performed, and thus all of the carts having the leading and following function following the leading subject can be guided to the destination safely.

In addition, a movement trajectory can be planned on the basis of state information and environmental information, and collision with obstacles can be prevented.

In addition, forward and backward situations can be monitored at the same time by providing a forward information obtaining unit and a backward information obtaining unit.

In addition, carts having a leading and following function can autonomously move in a line by using a camera or a vision sensor for the forward information obtaining unit and the backward information obtaining unit, and without performing additional communication and without being affected by a communication delay.

In addition, a complex programming required for detecting identification information can be simplified by detecting identification information by the forward information obtaining unit and the backward information obtaining unit itself

In addition, a movement trajectory, which is estimated by interpolation, of the cart having the leading and following function is planned to follow a trajectory of the leading subject, and thus a smooth movement trajectory can be generated for a point where tracking is impossible due to obstacles.

In addition, by using driving modes having priories in an order of a stop mode, a standby mode, a tracking mode, and a following mode, driving can be possible by a combination of simple driving modes.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a conceptual diagram of a cart having a leading and following function according to an embodiment of the present invention; and

FIG. 2 is a view showing an example where multiple carts having a leading and following function of FIG. 1 move in a line.

### DETAILED DESCRIPTION OF THE INVENTION

The present invention can be modified in various manners and have various forms. Therefore, specific embodiments will be described in detail with reference to the accompanying drawings. However, the present invention is not limited to the specific embodiments, but may include all modifications, equivalents and substitutions within the scope of the present invention.

It will be understood that when an element is referred to as being “connected” or “coupled” to another element, it can be directly connected or coupled to the other element or intervening elements may be present.

In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Herein, with reference to the accompanying drawings, embodiments of the present invention will be described in detail. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. In addition, technical terms and scientific terms used in the present specification have the general meaning understood by those skilled in the art to which the present invention pertains unless otherwise defined, and a description for the known function and configuration obscuring the present invention will be omitted in the following description and the accompanying drawings. The drawings to be provided below are provided by way of example so that the idea of the present invention can be sufficiently delivered to a person skilled in the art to which the present invention pertains. Therefore, the present invention is not limited to the drawings provided below but may be modified in many different forms. In addition, like reference numerals designate like elements throughout the specification. In the drawings, same reference numerals denote same components throughout the disclosure.

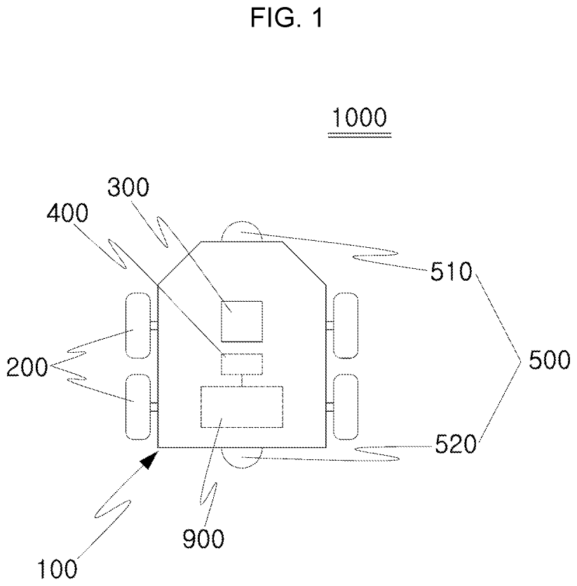

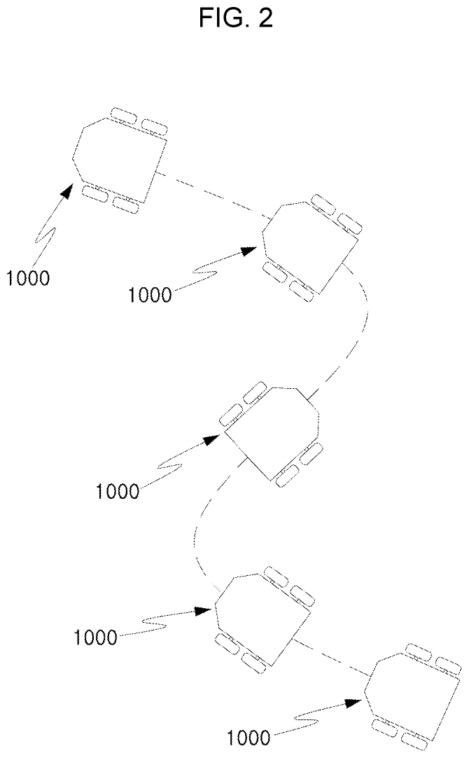

FIG. 1 is a view showing a conceptual diagram of a cart having a leading and following function according to an embodiment of the present invention, and FIG. 2 is a view showing an example where multiple carts having a leading and following function of FIG. 1 move in a line.

A cart having a leading and following function according to an embodiment of the present invention relates to a cart having a leading and following function which follows a leading subject. Multiple carts having a leading and following function can be used when moving a large amount of goods in large logistics centers or airports, and can move in a line.

As shown in FIG. 1, a cart having a leading and following function according to an embodiment of the present invention includes a cart body 100, a driving unit 200, an identification unit 300, a subject identification storage unit 400, an information obtaining unit 500, and a control unit 900.

The cart body 100 corresponds to a body of the cart having the leading and following function.

In the cart body 100, a storage space for storing goods may be provided.

The driving unit 200 is configured with a motor and wheels for driving, and coupled to the cart body 100.

The driving unit 200 is for moving the cart body 100, and is provided with wheels for moving the cart body 100 in a lower part or lateral part of the storage unit.

Wheels are round-shaped objects installed on a shaft for rotation purposes, but the present invention does not limit the shape of the wheel, various shapes such as a polygonal shape installed in the shaft for purpose of rotation can be applied.

In addition, the wheels may directly be in contact with the floor to move the storage unit 100. However, the storage unit 100 may move by rotating other components such as caterpillar or tracks.

In addition, the motor is a component for rotating the wheels, and may directly rotate the wheels. However, various structures may be applied to rotate the wheels such as indirectly rotating the wheels by using a gear, etc.

The identification unit 300 is provided with identification information. The identification information may be information that is transmitted through communication, or may be provided in various forms such as information obtained from an image, etc.

The information that is transmitted over communication may be a unique identifier of a communication device.

As an example of the unique identifier, a MAC (media access control) address, an international mobile station equipment identity (IMEI), a user device identification (UDID), a universally unique identifier (UUID), etc. are used.

The MAC address is an address provided to a network device in a MAC layer of a network structure, and generally, may be stored in a ROM of a network card.

The UDID is an identifier capable of identifying a user device, and is a kind of serial number.

The UUID refers to a number of 128-bit used for identifying an object or substance on Internet. The UUID is a nearly uniquely usable identifier consisting of a combination of space and time (up to about 3400 years), and is used for various purposes ranging from identifying objects of a short time to identifying permanent objects. Registration procedure for certification institutions is not required, but only a unique identification number of a program generating an UUDI is required. For example, when the MAC address of a certain product is stored in a specific server, an identifier for replacing the stored MAC address may be used for responding problems as leakage of personal information may occur.

In the above, various types of unique identification information (identifier) are described, and a single device may have multiple pieces of unique identification information.

For example, when communication using WiFi and Bluetooth is available, various types of unique identification information are included in a device such as an identifier (UDID) of the device itself, MAC address of a WiFi chip, MAC address of a Bluetooth chip, etc.

Information capable of obtaining from an image may be a specific figure, a 1D code, a 2D code (QR code), a 3D code, a sign recognized by using a vision sensor, etc.

Information capable of being obtained from an image may be provided in an upper side, a lower, side, and a lateral side when the information is obtained forwardly or backwardly, or may be provided on a front surface, a rear surface, a lateral surface when the information is obtained from one side.

In FIG. 1, a single identification unit 300 is shown as an example, but the present invention is not limited thereto. Multiple identification units 300 may be applied according to a type of the information obtaining unit 500 that will be described later.

The subject identification storage unit 400 is for storing identification information on a leading subject, on a following subject, or on a leading subject and a following subject.

The subject identification storage unit 400 is for storing information required for recognizing a leading subject, a following subject, or a leading subject and a following subject, and the information may be directly stored, or stored by obtaining information required for recognizing the following subject through the information obtaining unit 500 that will be described later.

Herein, the leading subject may be a person, an object, or another cart having a leading and following function which is provided with identification information, and the following subject may also be a person, an object, or another cart having a leading and following function which is provided with identification information.

For example, when a leading subject or following subject is a person, the person may wear a garment where identification information is printed, may carry a garment where a communication chip is integrated, or may carry a terminal.

As another example, when an autonomous driving robot is a leading subject which is moving at the first, and multiple carts having a leading and following function follow the leading subject as following subjects, a leading subject of the first cart having a leading and following function becomes the autonomous driving robot, a following subject becomes the second cart having a leading and following function. Accordingly, a leading subject of an n-th (n is natural number) cart having a leading and following function becomes an n−-th cart having a leading and following function, and a following subject becomes an n+1-th cart having a leading and following function, and the last cart having a leading and following function has only a leading subject and not a following subject.

When information required for recognizing a following subject is obtained and the obtained information is stored through the information obtaining unit 500 that will be described later, information may be stored in a database in advance which is used for determining whether or not information obtained through the information obtaining unit 500 is information required for recognizing a leading subject, a following subject, or a leading subject and a following subject. Whether or not being information required for recognizing a leading subject, a following subject, or a leading subject and a following subject may be determined by comparing the obtained information and the stored information. The above process may be performed by various units such as the control unit 900 that will be described later and the information obtaining unit 500.

As information used for determining whether or not being information required for recognizing a leading subject, a following subject, or a leading subject and a following subject, identification information may be directly used, or various examples may be used such as using additional information which represents identification information, etc.

For example, when a QR code is used as identification information, the QR code itself may be used for determining whether or not the code is information required for determining a leading subject, a following subject, or a leading subject and a following subject. Alternatively, an additional mark corresponding to the border of the QR code may be used for determining whether or not the code is information required for determining a leading subject, a following subject, or a leading subject and a following subject

When information required for determining a following subject is obtained and stored through the information obtaining unit 500, the cart having the leading and following function according to an embodiment of the present invention may include: a leading subject input unit (button, etc.) receiving a command to determine identification information on the leading subject; a leading subject input representing unit (lamp, etc.) representing whether or not the identification information on the leading subject is normally input; a following subject input unit (button, etc.) receiving a command to determine identification information on a following subject; and a following subject input representing unit (lamp, etc.) representing whether or not the identification information on the following subject is normally input.

Description will be made in detail assuming that the leading subject input unit and the following subject input unit are provided in a button, the leading subject input representing unit and the following subject input representing unit are provided in a lamp, and the lamp outputs red color when identification information is not input, and green color when identification information is input.

Assuming that the carts having the leading and following function are arranged to move in a driving order, when a button of a leading subject input unit of an n-th (n is natural number) cart having the leading and following function is pushed, identification information on an n−-th cart having the leading and following function is detected and stored by the n-th cart having the leading and following function, and then when the identification information is normally stored in the n-th cart having the leading and following function, a lamp of a leading subject input representing unit of the n-th cart having the leading and following function is switched from a red to green color.

When a button of a following subject input unit of the n-th (n is natural number) cart having the leading and following function is pushed, identification information on an n+1-th cart having the leading and following function is detected and stored by the n-th cart having the leading and following function, and then when the identification information is normally stored in the n-th cart having the leading and following function, a lamp of a following subject input representing unit of the n-th cart having the leading and following function is switched from a red to green color.

The first cart having the leading and following function does not have a leading subject, an thus stores identification information on a following subject, and the last cart having the leading and following function does not have a following subject, and thus stores identification information on a leading subject.

By setting as above, when a lamp of a leading subject input representing unit of the first cart having the leading and following function and a lamp of a following subject input representing unit of the last cart having the leading and following function outputs red, and other lamps of all leading subject input representing units are switched to green, it may be determined that a default setting for all carts having a leading and following function to move in a line has been completed.

The information obtaining unit 500 obtains (captures, senses) surrounding information.

The information obtaining unit 500 obtains identification information stored in the subject identification storage unit 400, and obtains surrounding information required for planning a movement trajectory of the cart having the leading and following function so as to avoid collisions.

When identification information on the leading subject is stored in the subject identification storage unit 400, that is, when the leading subject is present, the control unit 900 controls the driving unit 200 to follow the leading subject by planning (avoiding collision) a movement trajectory on the basis of identification information on the leading subject, state information on the leading subject, and surrounding environmental information which are obtained from information obtained by the information obtaining unit 500. When identification information on the following subject is stored in the subject identification storage unit 400, that is, when the following subject is present, the control unit 900 controls the driving unit 200 to decrease in velocity or to stop moving: when a distance with the following subject becomes equal to or greater than a specific distance; when identification information on the following subject is not detected by the information obtaining unit 500; or when the identification information on the following subject is not detected and a predetermined time has elapsed.

In other words, when only the leading subject is present, following of the leading subject may be performed; when only the following subject is present, decreasing in velocity or stopping moving may be performed according to a situation such that the following subject easily follows the leading subject; and when both of the leading subject and the following subject are present, decreasing in velocity or stopping moving may be performed according to a situation such that the following subject easily follows the leading subject while performing following to the leading subject.

When both of the leading subject and the following subject are present, it is preferable to apply control priority such that the following subject easily follows the leading subject.

Accordingly, the first leading subject takes the carts having the leading and following function that follow in sequence to a destination. (refer to FIG. 2)

Describing in detail will be done by using an example where a cart having a leading and following function to which a trajectory is input is the first leading subject, and multiple carts having a leading and following function follow the first leading subject as following subjects.

When an n-th 1 cart having a leading and following function stops moving by expecting collision, the carts having the leading and following function following the n-th cart having the leading and following function also stop. In addition, carts having a leading and following function which are in front of the n-th cart having the leading and following function also stop when a distance with the cart having the leading and following function being the following subject (hereinafter, following subject) becomes equal to or greater than a specific distance, and waits until the following subject starts moving.

In addition, when identification information on the following subject is not detected due to cornering, obstacles, etc., or when the identification information on the following subject is not detected and a predetermined time has elapsed, waiting for the following subject may be performed.

Herein, state information on the leading subject includes distance information with the cart having the leading and following function on a movement trajectory, and posture information on the leading subject.

In addition, state information on the leading subject may further include position information on the leading subject, velocity information on the leading subject, etc.

In addition, the environmental information includes static obstacle information and dynamic obstacle information.

Classifying into a static obstacle may be determined by comparing with map information input in advance, and classifying into a dynamic obstacle may be determined by whether or not motion information is detected.

The information obtaining unit 500 of the cart having the leading and following function according to an embodiment of the present invention obtains state information, environmental information, or state information and environmental information.

The information obtaining unit 500 may directly obtain state information, environmental information, or state information and environmental information. Alternatively, various sensors may be used such as ultrasonic sensor, radar sensor, depth sensor, etc. when state information, environmental information, or state information and environmental information are obtained or calculated therefrom such as obtaining values required for calculating state information, environmental information, or state information and environmental information.

The information obtaining unit 500 of the cart having the leading and following function according to an embodiment of the present invention may include: a forward information obtaining unit 510 obtaining forward information; and a backward information obtaining unit 520 obtaining a backward information.

The forward information obtaining unit 510 is oriented forward to obtain forward information. Herein, the forward means the front part of the cart having the leading and following function.

The forward information obtaining unit 510 may determine identification information on the leading subject, obtain state information on the leading subject, and use the obtained information for collecting information for preventing collision on the basis of surrounding environmental information.

The backward information obtaining unit 520 is oriented backward to obtain backward information. Herein, the backward means the rear part of the cart having the leading and following function.

The backward information obtaining unit 520 may determine identification information on the following subject, and may use the determined information for determining whether or not the following subject is following.

The information obtaining unit 500 of the cart having the leading and following function according to an embodiment of the present invention obtains identification information on the leading subject which is stored in the subject identification storage unit 400 by using information obtained by the forward information obtaining unit 510, and obtains identification information on the following subject which is stored in the subject identification storage unit 400 by using information obtained by the backward information obtaining unit 520.

In other words, the information obtaining unit 500 may obtain identification information from information obtained by the forward information obtaining unit 510 and the backward information obtaining unit 520.

In the above, the information obtaining unit 500 obtains the identification information as an example, but the present invention is not limited thereto. Various examples may be used such as the control unit 900 or additional identification unit obtains identification information from information obtained by the information obtaining unit 500.

The forward information obtaining unit 510 and the backward information obtaining unit 520 of the cart having the leading and following function according to an embodiment of the present invention may be respectively provided with a camera or a vision sensor.

In other words, a camera or a vision sensor may be used for the forward information obtaining unit 510 and the backward information obtaining unit 520.

A vision sensor (smart vision) is an image processing system in a sensor form. The sensor is compact and an imaging sensor, a lighting device (or connection unit therefor), an optical device (or interchangeable lens), hardware/software are integrated in a housing suitable for the industry field.

A vision sensor may recognize an object and a scene, and perform evaluation for the same.

One feature of the vision sensor is simplicity. An imaging processing system may be applied to a production process by qualified staff or cost-intensive external integrators. However, the vision sensor may be used without prior knowledge due to application specific characteristics. The motto of the vision sensor is simple “setting parameter” rather than complex “programming”. The vision sensor provides ready-to-use function blocks through into a PLC. An Ethernet process interface is used for data transmission, parameter setting, and remote maintenance.

In addition, a switching output for outputting a signal of a test result is provided in all units.

Therefore, the vision sensor provides user convenience as a binary sensor.

Herein, it is preferable for identification information to be information capable of being obtained from a specific figure, a 1D code, a 2D code (QR code, etc.), a 3D code, an image that is recognized by a vision sensor, etc.

In other words, identification information may be obtained from image information obtained by a camera or a vision sensor.

Using a camera or a vision sensor as the information obtaining unit 500 is for enabling movement in a line without performing additional communication, and is to be unaffected by a communication delay.

The forward information obtaining unit 510 of the cart having the leading and following function according to an embodiment of the present invention determines identification information on the leading subject which is stored in the subject identification storage unit 400 by using information obtained by itself, and the backward information obtaining unit 520 determines identification information on the following subject which is stored in the subject identification storage unit 400 by using information obtained by itself.

In other words, the forward information obtaining unit 510 and the backward information obtaining unit 520 may respectively perform functions of determining identification information.

In the above, an example is used where the forward information obtaining unit 510 and the backward information obtaining unit 520 respectively determine identification information, but the present invention is not limited thereto. Various examples may be used such as the control unit 900 or additional identification unit determines identification information from information obtained by the forward information obtaining unit 510 and the backward information obtaining unit 520.

The control unit 900 of the cart having the leading and following function according to an embodiment of the present invention estimates a trajectory of the leading subject on the basis of a position and a direction of the cart having the leading and following function by using interpolation, and plans a movement trajectory of the cart having the leading and following function so as to follow the estimated trajectory.

Interpolation is a method of estimating an unknown value by using given data.

When a shape of a function f(x) of a parameter x is unknown, but a function value f(xi) of at least two parameter values xi(i=1,2, . . . ,n) which have a certain interval (regardless of uniform interval or non-uniform interval) is known, interpolation means to estimate a function value of an arbitrary x within the interval. Interpolation is used when estimating a value at an unobserved point based on an observed value that has been obtained through an experiment or observation, or obtaining a function value that is not present in a function table, such as a log table. A simplest method obtains a function value to be obtained by drawing a curve along points in each of which a parameter is set as an x coordinate and a known function value for the parameter is set as a y coordinate.

The control unit 900 of the cart having the leading and following function according to an embodiment of the present invention controls the driving unit 200 on the basis of driving modes including: a stopping mode stopping at a given maximum decreasing velocity and maintaining a stop state, a standby mode stopping by decreasing in velocity at a predetermined acceleration and maintaining a stop state, a tracking mode following a planned movement trajectory in a predetermined operation manner, and a following mode following a leading subject while maintaining a target distance D with the leading subject. Herein, the target distance D may vary according to a driving situation. Priorities of the driving modes are a stop mode, a standby mode, a tracking mode, and a following mode.

Herein, the target distance D may be designated as a range (for example: 1 to 5 m).

The control unit 900 of the cart having the leading and following function according to an embodiment of the present invention may control the driving unit 200 in a stop mode, a standby mode, a tracking mode, and a following mode, and the driving unit 200 may operate according to the priority of the driving mode.

In other words, in each cart having a leading and following function, four driving modes are operated according to a condition, and an algorithm for the same may be executed in every predetermined period.

In a stop mode, the cart having the leading and following function stops at a given maximum decreasing velocity and maintains a stop state.

In a standby mode, the cart having the leading and following function stops by decreasing in velocity at a predetermined acceleration a_{wait} and maintains a stop state.

A tracking mode is a given mode for following a movement trajectory of the leading subject (a cart having a leading and following function, etc.), and in the tracking mode, a target distance D with the leading subject (a cart having a leading and following function, etc.) may be disregarded. A last point of the movement trajectory in the tracking mode is a point where the leading subject (a cart having a leading and following function, etc.) is recognized last, and following may be performed by approaching the last point of the movement trajectory in the tracking mode by gradually decreasing in velocity. Subsequently, when arriving the last point of the movement trajectory is done in the tracking mode, the driving mode may be switched to a stop mode, a standby mode, or a following mode.

In a following mode, following the movement trajectory of the leading subject (a cart having a leading and following function, etc.) is performed while maintaining a real distance Dᵣₑₐₗ with the leading subject (a cart having a leading and following function, etc.) to be a predefined target distance D by using the equation below.

Dᵣₑₐₗ>D: cart having leading and following function increases in velocity.

Dᵣₑₐₗ=D: cart having leading and following function maintains a current velocity.

Dᵣₑₐₗ<D: cart having leading and following function decreases in velocity.

The control unit 900 of the cart having the leading and following function according to an embodiment of the present invention controls the driving unit 200: in a stop mode when collision with an obstacle is expected within a designated time, when no more trajectory to move remains, or when an external stop button is activated: in a standby mode when a distance with the following subject registered on the movement trajectory becomes equal to or greater than a specific distance L, or when a recognition failure elapsing time tᵢₙᵥ that is measured from the moment that the recognition of the following subject is failed becomes equal to or greater than a predefined elapsing time t_{inv,threshold}; in a tracking mode when the identification information on the leading subject is not detected; and in a following mode when other driving modes are not operated.

In other words, a condition to switch to each driving mode may be as follows.

A condition for switching to a stop mode may include a case where collision with an external obstacle (all object other than the cart having the leading and following function itself) is expected within a designated time t_{collision} when following the movement trajectory, where no more trajectory to move remains, or where an external stop button is activated.

A condition for switching to a standby mode includes a case where a distance with the following subject registered in the movement trajectory becomes equal to or greater than a specific distance L, or where a recognition failure elapsing time tᵢₙᵥ that is measured from the moment that the recognition of the following subject is failed becomes equal to or greater than a maximum predefined elapsing time t_{inv,threshold}.

A condition for switching to a tracking mode includes a case where the leading subject (a cart having a leading and following function, etc.) is not recognized.

A condition for switching to a following mode includes a case where the other driving modes are not operated. In other words, a following mode is a general operation mode.

In the above, a stop mode, a standby mode, a tracking mode, and a following mode are used as an example of the driving modes so as the driving modes are provided in combination of modes in the simplest manner, but the present invention is not limited thereto. Various driving modes may be further included such as a deceleration mode decreasing in velocity according to a preset rule, an obstacle avoiding mode, a reverse driving mode that drives backwardly the past movement trajectory, etc.

A condition for switching to a reverse driving mode includes a case where a recognition failure elapsing time tᵢₙᵥ that is measured from the moment that the recognition of the following subject is failed becomes equal to or greater than a maximum predefined elapsing time t_{inv,threshold}.

A detailed data form and a calculation example will be described assuming that a camera or a vision sensor is used for the information obtaining unit 500.

Prior to the description, parameters and constants required for an algorithm are defined and described as follows.

D is a target distance with the cart having the leading and following function.

Dᵣₑₐₗ is a real measured distance with the leading subject (a cart having a leading and following function, etc.).

D_{back} is a real measured distance with the following subject.

L is a minimum distance with the following subject at which the cart having the leading and following function switches to a standby mode.

B is a minimum difference value with the leading subject (a cart having a leading and following function, etc.) for using an estimation method by approximating a trajectory of the leading subject (a cart having a leading and following function, etc.) to a curve.

t_{collision} is a minimum time in which collision is expected.

tᵢₙᵥ is a recognition failure elapsing time measured from the moment that the following subject is not recognized.

t_{inv,threshold} is a minimum value of tᵢₙᵥ at which the cart having the leading and following function switches to a standby mode.

a_{wait} is an acceleration used in a standby mode by the cart having the leading and following function.

k is a time index of an elapsing time through dead reckoning using an odometry of the cart having the leading and following function itself, and increases every 10 ms in the present example.

K is an index representing a current time in the time index of dead reckoning.

xₖ is a posture (pose) of the cart having the leading and following function at a time where a time index is k.

pₖ is a position coordinate of the cart having the leading and following function at a time where a time index is k.

θₖ is a direction of the cart having the leading and following function at a time where a time index is k.

m is a recognition index of the leading subject (a cart having a leading and following function, etc.), and increases every 50 ms in the present example.

M is a recognition index of the leading subject (a cart having a leading and following function, etc.) at a time where the leading subject (a cart having a leading and following function, etc.) is recognized last.

Δx̅ₘ is a posture difference between the leading subject (a cart having a leading and following function, etc.) and the cart having the leading and following function at a time where a recognition index of the leading subject (a cart having a leading and following function, etc.) is m.

x̅ₘ is a posture of the leading subject (a cart having a leading and following function, etc.) which is estimated at a time where a recognition index of the leading subject (a cart having a leading and following function, etc.) is m.

f_{f→w}(Δx̅ₘ, xₖ) is a function of transforming a posture of the leading subject (a cart having a leading and following function, etc.) in a global coordinate system by using a posture difference value between the cart having the leading and following function and the leading subject (a cart having a leading and following function, etc.), and a posture value of the cart having the leading and following function.

x̅ₘ is a partial trajectory of the leading subject (a cart having a leading and following function, etc.) which is estimated at a time where an recognition index of the leading subject (a cart having a leading and following function, etc.) is m. Herein, a start point and an ending point are connected in a straight line.

X̅ is an estimated trajectory of the leading subject (a cart having a leading and following function, etc.). X̅ is obtained by connecting pieces of the trajectory.

r is a number of virtual points used in a method of estimating by approximating a trajectory of the leading subject (a cart having a leading and following function, etc.) to a curve.

xₖ^{r} is a posture of the cart having the leading and following function at a time where a time index is k, and which is projected on a trajectory of the leading subject (a cart having a leading and following function, etc.).

Δpₖ^{r} is a difference value of a position with the leading subject (a cart having a leading and following function, etc.) at a time where a time index is k on the basis of a posture xₖ′ of the cart having the leading and following function projected on the trajectory of the leading subject (a cart having a leading and following function, etc.).

p̅ is a position at an arbitrary time on the estimated trajectory of the leading subject (a cart having a leading and following function, etc.).

θ̅ is a direction (heading angle) on the estimated trajectory of the leading subject (a cart having a leading and following function, etc.).

x̅ is a posture of the cart having the leading and following function at an arbitrary time on the estimated trajectory of the leading subject (a cart having a leading and following function, etc.).

λ is a weighting value required for calculating a posture of the cart having the leading and following function by projecting on the trajectory of the leading subject (a cart having a leading and following function, etc.), and represented in a real number other than a negative value.

q is a recognition index of the leading subject (a cart having a leading and following function, etc.) from the partial trajectory X̅ₘ of the leading subject (a cart having a leading and following function, etc.) which includes xₖ′ projected on the trajectory of the leading subject (a cart having a leading and following function, etc.) to an end point in a direction to leading subject (a cart having a leading and following function, etc.).

n is a recognition index of the following subject, and increases every 50 ms in the present example.

N is a recognition index of the following subject at a time where the following subject is recognized last.

Δ\hat{x}ₙ is a posture difference between following subject and the cart having the leading and following function at a time where a recognition index of the following subject is n.

f_{b→ω}(Δ\hat{x}ₙ, xₖ) is a function of transforming a posture of the following subject in a global coordinate system by using a posture difference value between the cart having the leading and following function and the following subject, and a posture value of the cart having the leading and following function.

\hat{x}ₙ is a posture of the following subject which is estimated at a time where a recognition index of the following subject is n.

\hat{x}ₙ′ is a posture of the following subject which is projected on the trajectory of the leading subject (a cart having a leading and following function, etc.) at a time where a recognition index of the following subject is n.

Δpₖ^{rr} is a difference value of a position with the following subject on the basis of \hat{x}ₙ′ that is a posture of the cart having the leading and following function projected on the trajectory of the leading subject (a cart having a leading and following function, etc.) at a time where a time index is k.

λ_{b} is a weighting value required for calculating a posture of the following subject by projecting on the trajectory of the leading subject (a cart having a leading and following function, etc.), and represented in a real number other than a negative value.

l is a recognition index of the leading subject (a cart having a leading and following function, etc.) from the partial trajectory X̅ₘ of the leading subject (a cart having a leading and following function, etc.) which includes \hat{x}ₙ′ that is a posture of the following subject projected on the trajectory of the leading subject (a cart having a leading and following function, etc.) to an end point in a direction to the leading subject (a cart having a leading and following function, etc.).

Each cart having a leading and following function may be provided with information below, the information includes:

1) Surrounding environmental information detected by using a sensor,

2) A distance D that has to be maintained with the leading subject (a cart having a leading and following function, etc.). The distance means a distance on a movement trajectory of the leading subject (a cart having a leading and following function, etc.) rather than a Euclidean distance,

3) A minimum distance L used for waiting for the following subject so as not to miss the same,

4) A minimum recognition failure elapsing time t_{inv,threshold} of the following subject which is used for waiting for the following subject when the following subject is not recognized, and

5) Identification information on the leading subject (a cart having a leading and following function, etc.) and the following subject. The identification information includes information that may be identified by obtaining the same by using a camera or vision sensor such as a QR code, a barcode, etc.

In addition to the above information, the first cart having the leading and following function may include additional information required for movement. For example, the additional information may include a global map of a movement environment, a global movement plan, a target point, a movement trajectory of a subject, etc.

The cart having the leading and following function may include therein functions described below.

Whether or not the leading subject (a cart having a leading and following function, etc.) is recognized may be determined by using a forward camera or vision sensor of the cart having the leading and following function.

Whether or not the following subject is recognized may be determined by using a rear-facing camera or vision sensor of the cart having the leading and following function.

A relative posture difference value with the leading subject (a cart having a leading and following function, etc.) may be estimated.

A movement trajectory of the leading subject (a cart having a leading and following function, etc.) may be estimated.

A distance between the leading subject (a cart having a leading and following function, etc.) and the cart having the leading and following function may be calculated on a movement trajectory of the leading subject (a cart having a leading and following function, etc.).

A distance between the cart having the leading and following function and the following subject may be calculated on a movement trajectory of the leading subject the (a cart having a leading and following function, etc.).

Each cart having a leading and following function may estimate a posture thereof in an absolute coordinate system.

A new cart having a leading and following function may be registered to the line of the carts having the leading and following function, or an existing cart having a leading and following function may be removed therefrom.

A posture xₖ of the cart having the leading and following function may be updated through dead reckoning at every predetermined time. Herein, the posture may include a position pₖ, and a direction (orientation) θₖ of the cart having the leading and following function. k=0,1, . . . ,K is a time index for dead reckoning. Hereinafter, in the description, as the time index, for example, 10 ms is used. K is a time index of a current time.

A posture difference with the leading subject (a cart having a leading and following function, etc.) is represented as Δx̅ₘ. Herein, m is a recognition index of the leading subject (a cart having a leading and following function, etc.), and may be defined as a value differing from k. Hereinafter, in the description, as the recognition index m, for example, 50 ms is used.

In other words, every 50 ms, when Δx̅ₘ is calculated by recognizing the leading subject (a cart having a leading and following function, etc.) by using the forward camera or a vision sensor, a value of m is increased by 1. When the leading subject (a cart having a leading and following function, etc.) is not recognized, the value of m is not increased. The value of m is not increased when the leading subject (a cart having a leading and following function, etc.) is out of a sensing range. A time where the leading subject (a cart having a leading and following function, etc.) is recognized last is represented as M, and M becomes a maximum value of m.

When a recognition index of the leading subject (a cart having a leading and following function, etc.) at a current time is m, an estimated posture of the leading subject (a cart having a leading and following function, etc.) is represented as x̅ₘ, and calculated as below by using a function f_{f→w}.

x̅ₘ=f_{f→w}(Δ\hat{x}ₘ, xₖ).

When a distance difference value between x̅ₘ and x̅ₘ₋₁ is a given reference value B, a trajectory of the leading subject (a cart having a leading and following function, etc.) may be calculated as below.

X̅=U_{m=1,2, . . . ,M} X̅ₘ.

In the above equation, X̅ₘ may be represented as below.

X̅ₘ={x̅|∀μ=[0,1], X̅=X̅+μ(X̅-X̅ₘ₋₁)}.

When distance difference value between x̅ₘ and x̅ₘ₋₁ at m is greater than B, a trajectory of the leading subject (a cart having a leading and following function, etc.) is regarded as a curve. On the above curve, r virtual points are added between x̅ₘ and x̅ₘ₋₁ so as to obtain the equation below.

X̅=U_{m=1,2, . . . ,M+r} X̅ₘ.

In the above equation, X̅ₘ may be represented as below.

X̅ₘ={X̅|∀μ=[0,1], x̅=x̅ₘ₋₁+μ(X̅-X̅ₘ₋₁)}.

A posture xₖ′ of the cart having the leading and following function projected on a trajectory of the leading subject (a cart having a leading and following function, etc.) at a time where a time index is k may be calculated as below.

$${x}_{k}^{′} = {arg min}_{\overline{x} ( \overline{p} , \overline{θ} ) ∈ \overline{X}} \{ ‖ {p}_{k} - \overline{p} ‖ + λ ( {θ}_{k} - \overline{θ} ) \} ,$$

In the above equation, λ is a weighting value represented in a real number other than a negative value. For example, when the weighting value is set to be small, a position error of xₖ′ and xₖ is calculated to be smaller than a movement direction error. The weighting value may be adaptively set according to a surrounding environment of the cart having the leading and following function.

Dᵣₑₐₗ is calculated as a distance Δpₖ′ to the leading subject (a cart having a leading and following function, etc.) on a trajectory from X̅ of the leading subject (a cart having a leading and following function, etc.). A partial trajectory X̅ₘ, of the leading subject (a cart having a leading and following function, etc.) which includes xₖ′ projected on the trajectory of the leading subject (a cart having a leading and following function, etc.) is determined, and the entire trajectory may be obtained as below by adding all pieces of trajectories up to a point where the leading subject (a cart having a leading and following function, etc.) is recognized last.

$$Δ {p}_{k}^{′} = {\sum }_{m = q + 1}^{M} \{ ‖ {\overline{p}}_{m + 1} - {\overline{p}}_{m} ‖ \} + ‖ {p}_{k}^{′} - {p}_{q} ‖ .$$

In the above equation, p̅ₘ means a position value belonging to x̅ₘ, q means a recognition index of an end point in a direction to the leading subject (a cart having a leading and following function, etc.) within a piece trajectory X̅ₘ of the leading subject (a cart having a leading and following function, etc.) which includes xₖ′ projected on the trajectory X̅ of the leading subject (a cart having a leading and following function, etc.), and may be calculate as below.

q=max {m∈{1,2, . . . , M}|xₖ′∈X̅ₘ}

A posture difference with the following subject is represented as Δ\hat{x}ₙ. In the above equation, n is a recognition index of the following subject, and may be increased in a method differing from k and m. In the present example, description is made assuming that n is increased by 1 at every 50 ms.

In other words, when Δ\hat{x}ₙ is calculated by recognizing the following subject at every 50 ms by using the rear-facing camera or a vision sensor, a value of n is increased. Alternatively, when the following subject is not recognized, the value of n is not increased. The value of n is not increased when the following subject is out of a sensing range. A time where the following is recognized last is represented as N, and N becomes a maximum value of n.

When a recognition index of the following subject at a current time is n, a measured posture of the following subject is represented as Δ\hat{x}ₙ, and may be calculated as below by using a function f_{b→ω}.

\hat{x}ₙ=f_{b→ω}(Δ\hat{x}ₙ, xₖ).

A posture \hat{x}_{N}′ of the following subject and which is projected on the trajectory X̅ of the leading subject (a cart having a leading and following function, etc.) is calculated as below.

$${\hat{x}}_{N}^{′} = {arg min}_{\overline{x} ( \overline{p} , \overline{θ} ) ∈ \overline{X}} \{ ‖ {\overline{p}}_{N}^{′} - \overline{p} ‖ + {λ}_{b} ( {\hat{θ}}_{N}^{′} - \overline{θ} ) \} ,$$

In the above equation, λ_{b} is a weighting value represented in a real number other than a negative value. For example, when the weighting value is set to be small, a position error of \hat{x}_{N}′ and \hat{x}_{N} is calculated to be smaller than a movement direction error. The weighting value is may be adaptively set according to a surrounding environment of the cart having the leading and following function.

D_{back} is calculated as a distance Δpₖ″ on the trajectory between the cart having the leading and the following function and the following subject within the trajectory X̅ of the leading subject (a cart having a leading and following function, etc.).

A partial trajectory X̅ₘ of the leading subject (a cart having a leading and following function, etc.) including xₖ′ projected on the trajectory of the leading subject (a cart having a leading and following function, etc.) is determined, and the entire trajectory may be obtained as below by adding all pieces of trajectories up to a point where the leading subject (a cart having a leading and following function, etc.) is recognized last.

$$Δ {\hat{p}}_{N}^{″} = {\sum }_{m = l + 1}^{q - 1} \{ ‖ {\overline{p}}_{m} - {\overline{p}}_{m - 1} ‖ \} + ‖ {p}_{k}^{′} - {p}_{q - 1} ‖ + ‖ {\hat{p}}_{N}^{′} - {p}_{l} ‖$$

In the above equation, l means a recognition index of the leading subject (a cart having a leading and following function, etc.) at an end point in a direction to the leading subject (a cart having a leading and following function, etc.) within the partial trajectory X̅ₘ of the leading subject (a cart having a leading and following function, etc.) which includes \hat{x}_{N}′ projected on the trajectory X̅ of the leading subject (a cart having a leading and following function, etc.), and is calculated as below.

l=max {m∈{1,2, . . . , M}|\hat{x}_{N}′∈X̅ₘ}

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cart having a leading and following function, wherein the cart having the leading and following function (1000) follows a leading subject, the cart comprising:
a cart body (100);
a driving unit (200) configured with a motor and wheels for driving, and coupled to the cart body (100);
an identification unit (300) provided with identification information;
a subject identification storage unit (400) for storing identification information on the leading subject, a following subject, or the leading subject and the following subject;
an information obtaining unit (500) obtaining surrounding information; and
a control unit (900): controlling the driving unit (200) to follow the leading subject by planning a movement trajectory on the basis of the identification information on the leading subject, state information on the leading subject, and surrounding environmental information, which are determined from information obtained by the information obtaining unit (500), when the identification information on the leading subject is stored in the subject identification storage unit (400); and controlling the driving unit (200) to decrease in velocity or stop when the identification information on the following subject is stored in the subject identification storage unit (400), and when a distance with the following subject becomes equal to or greater than a specific distance, when the identification information on the following subject is not detected by the information obtaining unit (500), or when the identification information on the following subject is not detected and a predetermined time has elapsed.

2. The cart having the leading and following function of claim 1, wherein the state information includes distance information and posture information on the movement trajectory, and the environmental information includes static obstacle information and dynamic obstacle information.

3. The cart having the leading and following function of claim 1, wherein the information obtaining unit (500) obtains the state information, environmental information, or the state information and the environmental information.

4. The cart having the leading and following function of claim 1, wherein the information obtaining unit (500) includes:
a forward information obtaining unit (510) obtaining forward information; and
a backward information obtaining unit (520) obtaining backward information.

5. The cart having the leading and following function of claim 4, wherein the information obtaining unit (500) determines the identification information on the leading subject to be stored in the subject identification storage unit (400) from information obtained by the forward information obtaining unit (510), and determines the identification information on the following subject to be stored in the subject identification storage unit (400) from information obtained by the backward information obtaining unit (520).

6. The cart having the leading and following function of claim 4, wherein the forward information obtaining unit (510) and the backward information obtaining unit (520) are respectively provided with a camera or a vision sensor.

7. The cart having the leading and following function of claim 6, wherein the forward information obtaining unit (510) determines the identification information on the leading subject to be stored in the subject identification storage unit (400) from the information obtained by the forward information obtaining unit (510), and
the backward information obtaining unit (520) determines the identification information on the following subject to be stored in the subject identification storage unit (400) from information obtained by the backward information obtaining unit (520).

8. The cart having the leading and following function of claim 1, wherein the control unit (900) estimates a trajectory of the leading subject on the basis of a position and a direction of the cart having the leading and following function and a position and a direction of the leading subject by using interpolation, and plans the movement trajectory of the cart having the leading and following function to follow the trajectory.

9. The cart having the leading and following function of claim 1, wherein the control unit (900) controls the driving unit (200) by using driving modes including: a stop mode stopping at a given maximum velocity and maintaining a stop state; a standby mode stopping at a predetermined acceleration and maintaining a stop state; a tracking mode following the planned movement trajectory according to a preset operation method; and a following mode following the leading subject while maintaining a distance (D) with the leading subject, wherein priorities of the driving modes are in an order of the stop mode, the standby mode, the tracking mode, and the following mode.

10. The cart having the leading and following function of claim 9, wherein the control unit (900) controls the driving unit (200):
in the stop mode when collision with an external obstacle is expected within a designated time, when no more trajectory to move remains, and when an external stop button is activated;
in the standby mode when the distance with the following subject registered on the movement trajectory becomes equal to or greater than a specific distance (L), and when a recognition failure elapsing time (tᵢₙᵥ) measured from a moment where the following subject is recognized is equal to or greater than a predefined maximum waiting time (t_{inv,threshold});
in the tracking mode when the identification information on the leading subject is not detected; and
in the following mode when the other modes are not operated,
wherein the specific distance (L) varies according to a driving situation.
